(19) United States
(12) Patent Application Publication
(10) Pub. No.: US 2023/0158700 A1
(43) Pub. Date: May 25, 2023

(54) METHOD OF PRODUCING EAR LOOP MEMBERS FOR MASKS AND DEVICE FOR PRODUCING EAR LOOP MEMBERS FOR MASKS

(71) Applicant: ZUIKO CORPORATION, Ibaraki-shi, Osaka (JP)

(72) Inventor: Takahiro SHIMADA, Ibaraki-shi, Osaka (JP)

(21) Appl. No.: 17/919,353

(22) PCT Filed: Apr. 22, 2021
(86) PCT No.: PCT/JP2021/016281

§ 371 Date: Oct. 17, 2022

(30) Foreign Application Priority Data
Apr. 30, 2020 (JP) 2020-080851

(51) Int. Cl. B26F 1/02; A41H 3/00

(52) U.S. Cl. CPC B26F 1/02; A41H 3/00; A41D 13/1161

(57) ABSTRACT

Provided are a method of producing ear loop members for masks and a device for producing ear loop members for masks with which it is possible to inhibit a reduction in the production efficiency of the masks. The method of producing ear loop members (4) for masks includes a conveyance step (S2), a tension adjustment step (S3), and a forming step (S4). In the conveyance step (S2), a sheet (U1) having high stretchability in a high-stretch direction (DH) is conveyed in a conveyance direction (C10) running along the high-stretch direction (DH) while tension is applied in the high-stretch direction (DH) to the sheet (U1). In the tension adjustment step (S3), the tension in the conveyed sheet (U1) is adjusted. In the forming step (S4), ear loop members (4) are formed by cutting the sheet (U1) after the tension adjustment.

### TECHNICAL FIELD

The present invention relates to a method of producing ear loop members for masks and a device for producing ear loop members for masks.

### BACKGROUND ART

Conventionally, methods of producing masks are known where, as in patent document 1 (JP-A No. 2012-217651), a sheet serving as raw material for ear loop members and ear loop members that have been formed are conveyed along a low-stretch direction. Such methods of producing ear loop members can reduce deformation, distortion, and misalignment of the ear loop members.

### SUMMARY OF INVENTION

### Technical Problem

However, as described in patent document 1 (JP-A No. 2012-217651), in a case where, both of the mask bodies and the ear loop members are conveyed in the low-stretch direction, it is necessary to change the relative positions of the mask bodies and the ear loop members when the ear loop members and the mask bodies are combined. Such a step of changing the relative positions of the mask bodies and the ear loop members has a risk of reducing the production efficiency of the masks.

The present invention provides a method of producing ear loop members for masks and a device for producing ear loop members for masks with which it is possible to inhibit a reduction in the production efficiency of the masks.

### Solution to Problem

A method of producing ear loop members for masks of the present invention includes a conveyance step, a tension adjustment step, and a forming step. In the conveyance step, a sheet having high stretchability in a first direction is conveyed in a conveyance direction running along the first direction while tension is applied in the first direction to the sheet. In the tension adjustment step, the tension in the conveyed sheet is adjusted. In the forming step, ear loop members are formed by cutting the sheet after the tension adjustment.

Furthermore, a device for producing ear loop members for masks of the present invention includes a sheet roll, a conveyance mechanism, and a forming mechanism. In the sheet roll, a sheet having high stretchability in a first direction is wound. The conveyance mechanism conveys, in a conveyance direction running along the first direction, the sheet paid out from the sheet roll, while applying tension in the first direction to the sheet. The forming mechanism forms ear loop members by cutting the sheet conveyed by the conveyance mechanism. The conveyance mechanism has a tension adjustment mechanism. The tension adjustment mechanism is disposed upstream of the forming mechanism in the conveyance direction of the sheet and adjusts the tension in the sheet fed to the forming mechanism.

### Advantageous Effects of Invention

In the method of producing and the device for producing ear loop members for masks pertaining to the present invention, a step for changing the relative positions of the mask bodies and the ear loop members is unnecessary even in a case where the mask bodies are conveyed in the low-stretch direction, and a reduction in the production efficiency of the masks can be inhibited.

Furthermore, in the method of producing and the device for producing ear loop members for masks of the present invention, the sheet is conveyed in a state in which tension is applied in the first direction to the sheet, so even when the sheet is conveyed in the high-stretch direction, meandering and misalignment of the conveyed sheet can be inhibited.

Moreover, in the method of producing and the device for producing ear loop members for masks of the present invention, the adjustment of the tension in the conveyed sheet is performed before the ear loop members are formed, so the sheet deformed by tension can be returned to an appropriate dimension and then fed to the forming mechanism for forming the ear loop members. For that reason, the ear loop members having a predetermined shape can be accurately produced.

### BRIEF DESCRIPTION OF DRAWINGS

FIG. 1 is a drawing showing a donned state of a mask using ear loop members produced using a method of producing ear loop members and a device for producing ear loop members for masks pertaining to an embodiment of the present invention.

FIG. 2 is a front view of the mask of FIG. 1.

FIG. 3 is a back view of the mask of FIG. 2.

FIG. 4 is a drawing showing a state in which the ear loop members of the mask of FIG. 2 are opened outward.

FIG. 5 is a front view of a mask body of the mask of FIG. 2.

FIG. 6 is a front view of the ear loop members (an ear loop member assembly) produced using the method of producing ear loop members and device for producing ear loop members for masks pertaining to the embodiment of the present invention.

FIG. 7 is a diagram schematically showing a system for producing the mask of FIG. 1.

FIG. 8 is a diagram showing in a time series a process for producing the mask of FIG. 1.

FIG. 9 is a schematic configuration diagram of the ear loop member production device, an intermediate member production device, and a joining device for joining the ear loop members and the intermediate members.

FIG. 10 is a flowchart of steps for producing the ear loop members (the ear loop member assembly) of FIG. 6.

FIG. 11 is a drawing showing an example of changes in the width of a sheet during conveyance by a conveyance mechanism of the ear loop member production device of FIG. 9.

FIG. 12 is a diagram schematically showing part of an outer peripheral surface of a first cut roll of a forming mechanism of the ear loop member production device of FIG. 9.

FIG. 13 is a schematic sectional view for describing the internal structure of the first cut roll of the forming mechanism of the ear loop member production device of FIG. 9.

FIG. 14 is a drawing schematically showing part of an outer peripheral surface of a pattern roll of the joining device for joining the ear loop members and the intermediate members of FIG. 9.

### DESCRIPTION OF EMBODIMENT

An embodiment of a method of producing ear loop members and a device for producing ear loop members for masks pertaining to the present invention will be described with reference to the drawings.

It will be noted that the embodiment described below is merely an example of the present invention and is not intended to limit the scope of the present invention. It will be understood by those skilled in the art that various changes may be made to the following embodiment without departing from the spirit and scope of the invention described in the claims.

Here, first, a mask using ear loop members produced using the production method and the ear loop member production device of the present invention will be described, and then details will be described regarding the method of producing the ear loop members and the ear loop member production device.

(1) Mask

A mask 10 produced using ear loop members 4 produced by an ear loop member production device 1000 pertaining to an embodiment of the ear loop member production device of the invention and a method of producing the mask 10 will be described.

(1-1) Overall Configuration of Mask

The mask 10 is a hygienic device that is fastened to the face of a wearer and covers at least the mouth of the wearer. The mask 10 inhibits airborne microparticles from being taken in through the mouth and the like of the wearer. Examples of microparticles to be trapped by the mask 10 include viruses, bacteria, and pollen.

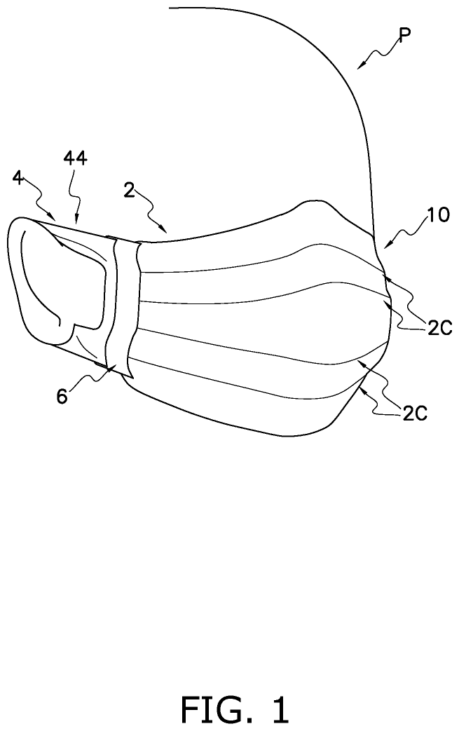

The overall configuration of the mask 10 will be described with reference to FIG. 1 to FIG. 3.

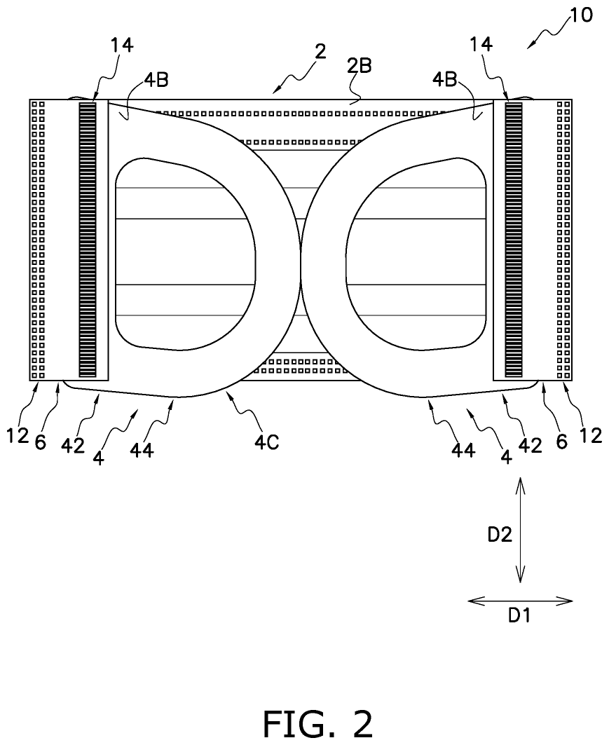

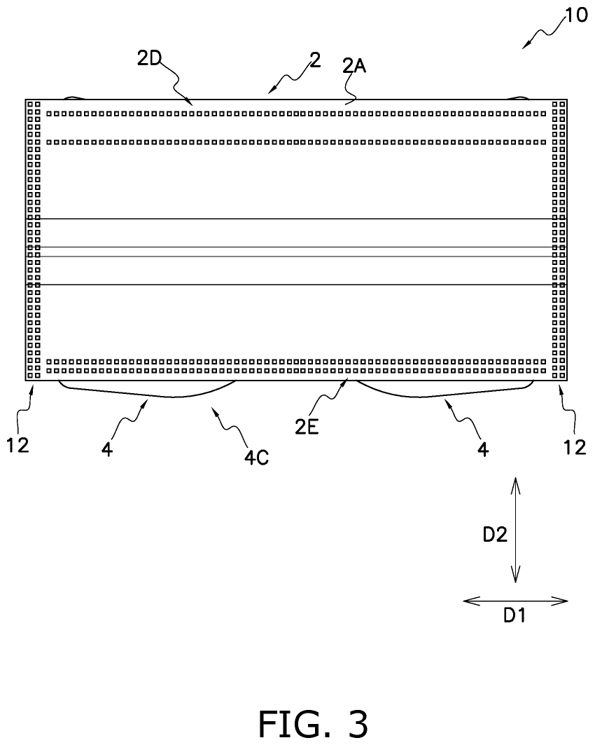

FIG. 1 is a drawing showing a state in which a wearer P is donning the mask 10. FIG. 2 and FIG. 3 are drawings illustrating the mask 10 in an unused state (before being donned by the wearer P as shown in FIG. 1). In other words, the unused mask 10 is provided to the wearer P in the form shown in FIG. 2 and FIG. 3. FIG. 2 is a front view of the mask 10. FIG. 3 is a back view of the mask 10.

It will be noted that the front view of the mask 10 in FIG. 2 is a view in which the unused mask 10 is seen facing a second surface 2B of a mask body 2 that covers the mouth and the like of the wearer P. The second surface 2B of the mask body 2 is the surface that does not oppose the face of the wearer P—in other words, the surface disposed on the outer side—when the wearer P dons the mask 10. The back view of the mask 10 in FIG. 3 is a view in which the unused mask 10 is seen facing a first surface 2A of the mask body 2. The first surface 2A of the mask body 2 is the surface that opposes the face of the wearer P—in other words, the surface disposed on the inner side—when the wearer P dons the mask 10.

The mask 10 mainly includes the mask body 2, a pair of intermediate members 6, and a pair of ear loop members 4 (see FIG. 1 to FIG. 3). The mask 10 is a so called a pleated mask in which the mask body 2 is provided with pleats 2C. In the mask 10, the ear loop members 4 are not directly joined to the mask body 2 but are connected to the mask body 2 via the intermediate members 6.

The mask body 2, the intermediate members 6, and the ear loop members 4 will be generally described.

The mask body 2 is a member that mainly covers the nose and mouth of the wearer P of the mask 10. In the unused mask 10, the mask body 2 is a planar member extending in a first direction D1 and a second direction D2 orthogonal to the first direction D1. In the present embodiment, the shape of the mask body 2 in an unused state is a rectangular shape in front view, although this should not be construed as being limiting. It will be noted that, here, the first direction D1 of the mask 10 is the longitudinal direction of the mask body 2. Furthermore, the second direction D2 of the mask 10 is the lateral direction of the mask body 2. When the mask 10 is donned by the wearer P, an end portion on one side of the mask body 2 in the first direction D1 is disposed on the right cheek of the wearer P and an end portion on the other side of the mask body 2 in the first direction D1 is disposed on the left cheek of the wearer P.

Each of the pair of intermediate members 6 is a member that interconnects the mask body 2 and one of the pair of ear loop members 4. Specifically, the intermediate members 6 include first joint portions 12 joined to the mask body 2 and second joint portions 14 joined to the ear loop members 4. The intermediate members 6 are welded to the mask body 2 and the ear loop members 4. However, the method of joining the intermediate members 6 to the mask body 2 and the ear loop members 4 is not limited to welding; for example, adhesion using an adhesive may be used. The ear loop members 4 are connected via the intermediate members 6 to the mask body 2 as a result of the intermediate members 6 being joined to the mask body 2 and the ear loop members 4. One of the pair of intermediate members 6 is disposed on the end portion of the mask body 2 on one side in the first direction D1, and the other of the pair of intermediate members 6 is disposed on the end portion of the mask body 2 on the other side in the first direction D1. The intermediate members 6 are sheet-like members extending in the first direction D1 and the second direction D2. In front view, the shape of the intermediate members 6 is a rectangular shape whose lateral direction coincides with the first direction D1 and whose longitudinal direction coincides with the second direction D2.

The pair of ear loop members 4 are portions fastened to the wearer P of the mask 10. The ear loop members 4 are sheet-like members. Seen from the front, the shape of the ear loop members 4 is a substantially D-shape or a substantially inverted D-shape (see FIG. 2). When the mask 10 is fastened, each of the pair of ear loop members 4 is fastened so as to be hooked around one ear of the wearer P.

(1-2) Detailed Configuration of Mask

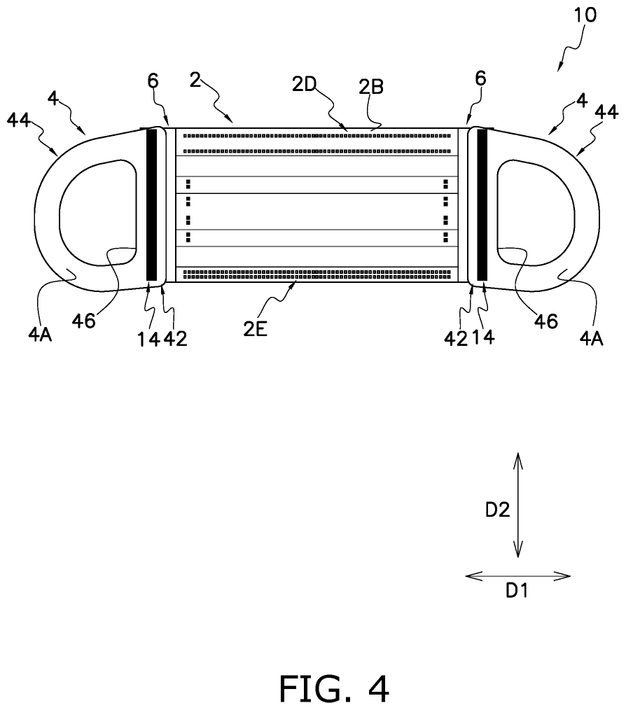

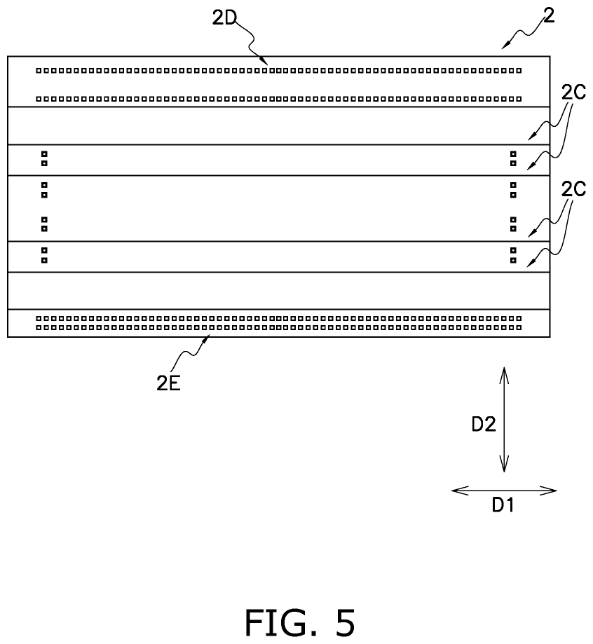

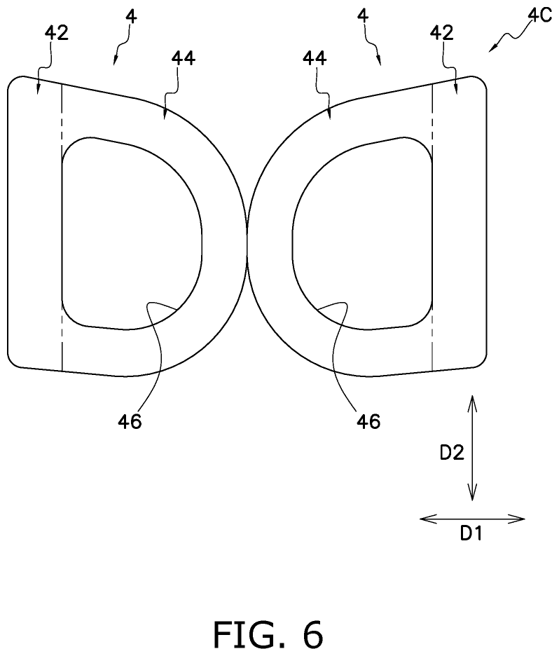

The mask 10 will be described in greater detail with reference to FIG. 4 to FIG. 6 in addition to FIG. 1 to FIG. 3. FIG. 4 is a drawing showing a state in which the ear loop members 4 of the mask 10 in the front view of FIG. 2 are opened outward. FIG. 5 is a front view of the mask body 2 by itself. FIG. 6 is a front view of the ear loop members 4 (specifically, an ear loop member assembly 4C including a pair of ear loop members 4) produced using the ear loop member production device 1000.

(1-2-1) Mask Body

The mask body 2 is formed by superposing plural sheets on top of each other in their thickness direction. For example, in the present embodiment, the mask body 2 is a sheet with a three-ply structure in which an outer sheet, an intermediate sheet, and an inner sheet are layered on top of each other in their thickness direction (not shown in the drawings). It will be noted that the number of sheet plies is merely exemplary, and plural intermediate sheets may be disposed between the outer sheet and the inner sheet.

In the present embodiment, the outer sheet, the intermediate sheet, and the inner sheet are all sheets made of plastic nonwoven fabric, although this should not be construed as limiting the material. The outer sheet has the second surface 2B of the mask body 2—in other words, the surface exposed to the outside of the mask body 2 in a donned state of the mask 10. The inner sheet has the first surface 2A of the mask body 2—in other words, the surface facing the wearer P in a donned state of the mask 10. The intermediate sheet has a predetermined ability to trap bacteria, viruses, dust, and the like. For the outer sheet and the inner sheet, a nonwoven fabric with specifications meeting desired conditions in the standpoint of air permeability, for example, is selected. For the intermediate sheet, a nonwoven fabric with specifications meeting desired conditions in the standpoint of ability to trap the microparticles to be trapped and air permeability is selected.

The outer sheet, the intermediate sheet, and the inner sheet are integrated as the mask body 2 by being welded together at joint portions 2D, 2E disposed on both end portions of the mask body 2 in the second direction D2 (see FIG. 5). The joint portions 2D, 2E are provided along the first direction D1 so as to span almost the entire length of the mask body 2 in the first direction D1 as shown in FIG. 5. It will be noted that welding is merely an example of a method of integrating the outer sheet, the intermediate sheet, and the inner sheet, and the sheets may be integrated using another method. For example, the outer sheet, the intermediate sheet, and the inner sheet may also be integrated by being adhered to each other with an adhesive at the joint portions 2D, 2E.

It will be noted that, in the joint portion 2D of the joint portions 2D, 2E that is disposed on the upper side (the nose side of the wearer P) when the mask 10 is donned, two rows of weld point groups extending in the first direction D1 may be disposed an interval apart from each other in the second direction D2 as shown in FIG. 5 to form a space capable of housing a nose strip member (not shown in the drawings) between the rows of weld point groups. The nose strip member is a member that can be deformed to fit the shape of the nose bridge of the wearer P when the mask 10 is donned. It will be noted that mask bodies equipped with nose strip members are commonly known, so detailed description thereof will be omitted here.

The mask body 2 is provided with plural pleats 2C. Specifically, in the mask body 2, pleats 2C extending in the first direction D1 are plurally disposed along the second direction D2. Because such pleats 2C are provided, the wearer P can don the mask 10 by expanding the mask body 2 in the second direction D2 at its center portion in the first direction D1. In other words, because the mask body 2 has the plural pleats 2C extending in the first direction D1, the mask body 2 has a structure in which its stretchability in the second direction D2 is high compared to its stretchability in the first direction D1.

Because the mask body 2 is configured to be expandable in the second direction D2 at its center portion in the first direction D1, a space can be formed between the mask body 2 and the mouth of the wearer P, whereby advantages such as it being easier for the wearer P to breathe even while donning the mask 10 are obtained. Furthermore, the pleats 2C of the mask body 2 provides effects such as the mask 10 being less likely to shift even when the wearer 10 talks while donning the mask 10. It will be noted that pleated masks are commonly known, so detailed description regarding the structure of the pleats 2C and the like will be omitted here.

(1-2-2) Intermediate Members

The intermediate members 6 are sheet-like members with a rectangular shape whose lateral direction coincides with the first direction D1 and whose longitudinal direction coincides with the second direction D2 (see FIG. 2). In the present embodiment, in the mask 10 in an unused state, the length of the intermediate members 6 in the second direction D2 is the same as the length of the mask body 2 in the second direction D2 (see FIG. 2).

In the unused mask 10, the intermediate members 6 are disposed on the front side of the mask body 2.

The intermediate members 6 are joined to end portions of the mask body 2 in the first direction D1 at one end side of each of the intermediate members 6 in the first direction D1 when the unused mask 10 is seen from the front side (see FIG. 2). In other words, the intermediate members 6 have, on one end side thereof in the first direction D1, the first joint portions 12 that are portions joined to the mask body 2 (see FIG. 2). Furthermore, the intermediate members 6 are joined to later-described base portions 42 of the ear loop members 4 at the other end side of each of the intermediate members 6 in the first direction D1 (the end portions on the opposite sides of the sides where the first joint portions 12 are provided) when the unused mask 10 is seen from the front side (see FIG. 2). In other words, the intermediate members 6 have, on the other end side thereof in the first direction D1, the second joint portions 14 that are portions joined to the ear loop members 4 (see FIG. 2). In the first direction D1, the second joint portion 14 provided in each intermediate member 6 is disposed closer to the center side of the mask body 2 than the first joint portion 12 is.

In the present embodiment, the intermediate members 6 are sheets made of plastic nonwoven fabric, although this should not be construed as limiting the material. Here, the intermediate members 6 are single-ply sheets, but they are not limited to this and may be sheets with a structure having multiple plies layered on top of each other in their thickness direction.

(1-2-3) Ear Loop Members

Each ear loop member 4 has a base portion 42, at least part of which is joined to the second joint portions 14 of the intermediate members 6, and an ear loop portion 44, which is hooked around the ears of the wearer P. The base portions 42 are substantially rectangular portions extending along the second direction D2. Referring to FIG. 6, the base portions 42 in the present embodiment are portions of the ear loop members 4 disposed on the outer sides of the long dashed double-short dashed lines. The shape of the ear loop portions 44 is a substantially C-shape or a substantially inverted C-shape in plan view. The ear loop portions 44 are connected to the base portions 42, so that overall the ear loop members 4 are each formed in the shape of a loop having a hole 46 in its center portion. The wearer P can, by inserting his/her ears through the holes 46 encircled by the base portions 42 and the ear loop portions 44, hook the ear loop portions 44 around his/her ears. In front view, the shape of each ear loop member 4 is a substantially D-shape or a substantially inverted D-shape.

It will be noted that in the unused mask 10, the pair of ear loop members 4 are joined to the pair of intermediate members 6 of the mask 10 in the form of an ear loop member assembly 4C in which the ear loop portions 44 are connected to each other as shown in FIG. 6.

The ear loop members 4 are sheets made of plastic nonwoven fabric, although this should not be construed as limiting the material. Here, the ear loop members 4 are single-ply sheets, but they are not limited to this and may be sheets with a structure having multiple plies layered on top of each other in their thickness direction. The ear loop members 4 each have a first surface 4A disposed on the back side and a second surface 4B disposed on the front side (the reverse side of the first surface 4A) in the unused mask 10.

The stretchability of the ear loop members 4 in the first direction D1 is greater than the stretchability of the ear loop members 4 in the second direction D2. By comparatively increasing the stretchability of the ear loop members 4 in the first direction D1, it becomes easier for the ear loop portions 44 to be looped over the ears of the wearer P and it becomes easier to bring the mask body 2 into close contact with the face of the wearer P after the wearer P dons the mask 10.

In the unused mask 10, the ear loop member assembly 4C (i.e., the pair of ear loop members 4) is disposed on the second surface 2B side of the mask body 2 (see FIG. 2). In other words, in the unused mask 10, the ear loop members 4 are disposed on the side of the mask body 2 not facing the wearer P when the wearer P dons the mask 10. In a state in which the ear loop members 4 are disposed on the second surface 2B side of the mask body 2, the first surfaces 4A of the ear loop members 4 face the second surface 2B of the mask body 2 and the second surfaces 4B of the ear loop members 4 face the front side of the mask body 2.

It will be noted that in the unused mask 10, in front view and in back view, each ear loop member 4 is disposed so as to protrude outside the mask body 2 in the second direction D2. For that reason, when the mask 10 is seen from the back side as shown in FIG. 3, parts of the ear loop members 4 disposed on the reverse side of the mask body 2 can be seen.

When the wearer P dons the mask 10, the wearer P separates the ear loop members 4 at a perforated portion (not shown in the drawings; a portion where the pair of ear loop members 4 are interconnected) formed in the ear loop member assembly 4C and then folds each of the pair of ear loop members 4 from the second surface 2B side to the first surface 2A side of the mask body 2 and loops them over his/her ears. Specifically, when the wearer P dons the mask 10, the wearer P rotates the ear loop members 4 away from the second surface 2B of the mask body 2 about the first joint portions 12 of the intermediate members 6 joined to the mask body 2 to thereby open the ear loop members 4 outward as shown in FIG. 4. Then, the wearer P dons the mask 10 by looping the pair of ear loop members 4 around both ears in a state in which the first surface 2A of the mask body 2 is facing his/her face. In a state in which the wearer P is donning the mask 10, the second surfaces 4B of the ear loop members 4 that had been exposed to the outside in the unused mask 10 now oppose the face of the wearer P.

It will be noted that when the wearer P is donning the mask 10, the second joint portions 14 of the intermediate members 6 directly (without other members such as the ear loop members 4 in between) oppose the face of the wearer P. Furthermore, when the wearer P is donning the mask 10, the parts of the mask body 2 connected to the first joint portions 12 of the intermediate members 6 directly oppose the face of the wearer P.

(1-3) Process for Producing Mask

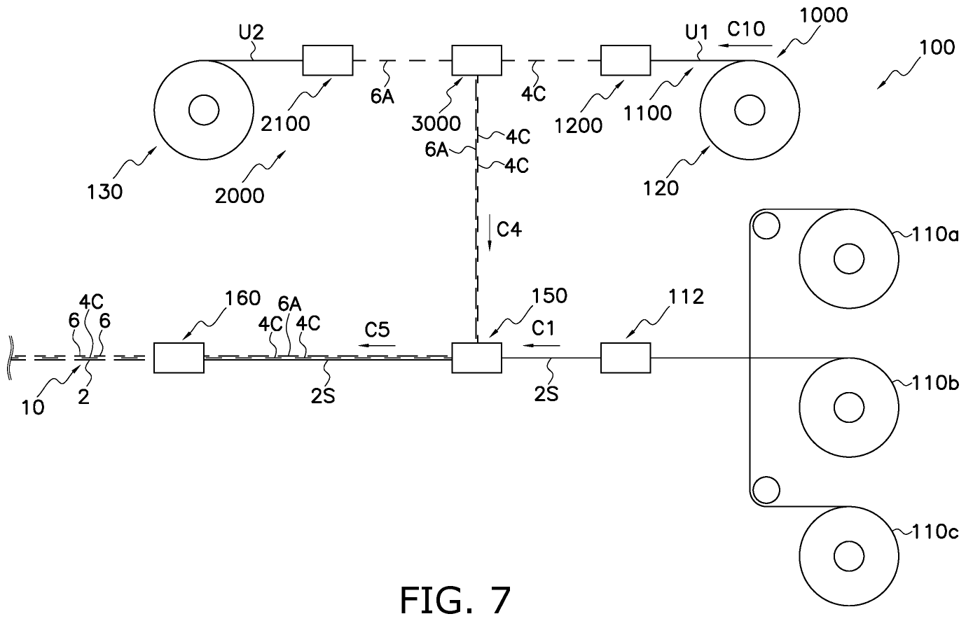

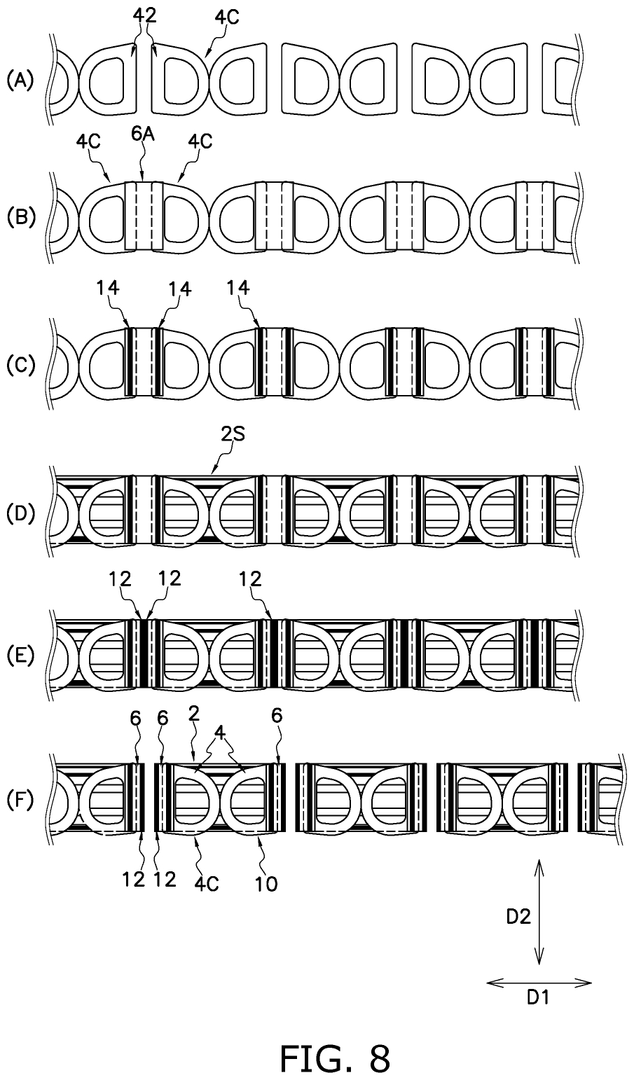

Next, a process for producing the mask 10 will be described with reference to FIG. 7 and FIG. 8. FIG. 7 is a diagram schematically showing a system 100 for producing the mask 10. FIG. 8 is a diagram showing in a time series the process for producing the mask 10 (a process for combining the mask body 2, the intermediate members 6, and the ear loop members 4).

It will be noted that details about the process for producing the ear loop members 4 and the ear loop member production device 1000 included in the system 100 for producing the mask 10 will be described later.

(1-3-1) Processes for Producing each of Mask Body, Intermediate Members, and Ear Loop Members

First, processes for producing each of the mask body 2, the intermediate members 6, and the ear loop members 4 will be generally described with reference to FIG. 7.

### Process for Producing Mask Body

The production system 100 mainly includes an outer sheet feeding device 110a, an intermediate sheet feeding device 110b, an inner sheet feeding device 110c, and an integration device 112 as devices for producing the mask body 2, more specifically, a mask body sheet 2S. It will be noted that, here, illustration and description of a device for inserting the nose strip member into the mask body 2 and a device for forming the pleats 2C in the mask body 2, which are used to produce the mask body 2, are omitted in order to keep description simple.

The outer sheet feeding device 110a feeds, from a sheet roll, a band-like long outer sheet for forming the outer sheet of the mask body 2. The intermediate sheet feeding device 110b feeds, from a sheet roll, a band-like long intermediate sheet for forming the intermediate sheet of the mask body 2. The inner sheet feeding device 110c feeds, from a sheet roll, a band-like long inner sheet for forming the inner sheet of the mask body 2. To make a band-like long sheet (called a mask body sheet 2S) in which mask bodies 2 are interconnected extending in the first direction D1 in the integration device 112, the outer sheet, the intermediate sheet, and the inner sheet fed by the sheet feeding devices 110a to 110c are superimposed on top of each other in the order of the outer sheet, the intermediate sheet, and the inner sheet, and are welded at the joint portions 2D, 2E. The mask body sheet 2S is conveyed by a conveyance mechanism (not shown in the drawings) to a joining device 150 described later. It will be noted that the mask body sheet 2S conveyed to the joining device 150 is conveyed along the direction in which the plural mask bodies 2 are interconnected. In other words, the mask bodies 2 are conveyed to the joining device 150 in an attitude where their conveyance direction C1 runs along the first direction D1 (a low-stretch direction).

### Process for Producing Intermediate Members

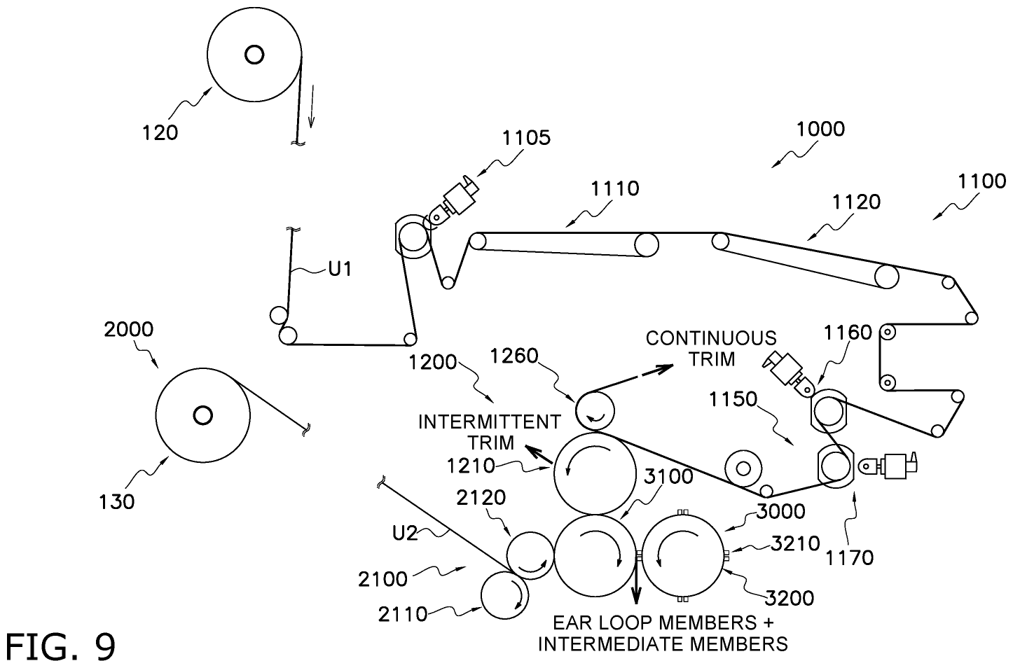

The production system 100 includes an intermediate member production device 2000 as a device for producing the intermediate members 6, more specifically, an intermediate member assembly 6A. The intermediate member production device 2000 will be described with further reference to FIG. 9. FIG. 9 is a schematic configuration diagram of the ear loop member production device 1000, the intermediate member production device 2000, and a joining device 3000 for joining the ear loop members 4 and the intermediate members 6.

The intermediate member production device 2000 includes a sheet roll 130 and a cutting device 2100 as shown in FIG. 7.

In the sheet roll 130, a band-like sheet U2 for forming the intermediate members 6 (the intermediate member assembly 6A) is wound. The sheet roll 130 feeds the band-like sheet U2 to the cutting device 2100.

The cutting device 2100 mainly includes a cut roll 2110 and an anvil roll 2120 (see FIG. 9). Here, to avoid confusion with other cut rolls and anvil rolls, the cut roll 2110 will be called a second cut roll 2110 and the anvil roll 2120 will be called a second anvil roll 2120.

The surface of the second cut roll 2110 is provided with cutting blades (not shown in the drawings) for cutting the sheet U2. The surface of the anvil roll 2120 is provided with suction holes (not shown in the drawings) for sucking and holding the sheet U2. Drive mechanisms (not shown in the drawings) including a motor and the like drives the second cut roll 2110 and the second anvil roll 2120 to rotate. For example, giving description based on FIG. 9, the second cut roll 2110 rotates clockwise and the second anvil roll 2120 rotates counterclockwise. When the second cut roll 2110 and the second anvil roll 2120 rotate in a state in which the sheet U2 is sandwiched between them, the sheet U2 is sandwiched between the cutters provided on the surface of the second cut roll 2110 and the second anvil roll 2120, the sheet U2 is cut at predetermined positions, and the intermediate member assembly 6A having predetermined dimensions is formed. It will be noted that the intermediate member assembly 6A is a sheet in which two intermediate members 6 are interconnected in the first direction D1.

The intermediate member assembly 6A that has been formed moves in accompaniment with the rotation of the second anvil roll 2120 that sucks and holds the intermediate member assembly 6A and is transferred to a later-described pattern anvil roll 3100 of the joining device 3000.

It will be noted that the sheet U2 and the intermediate members 6 (the intermediate member assembly 6A) are conveyed in an attitude where they are along the first direction D1 (the lateral direction of the intermediate members 6; a high-stretch direction) and are fed to the joining device 3000.

### Process for Producing Ear Loop Members

The production system 100 includes the ear loop member production device 1000 as a device for producing the ear loop members 4, more specifically, the ear loop member assembly 4C. The ear loop member production device 1000 includes a sheet roll 120, a conveyance mechanism 1100, and a forming mechanism 1200 as shown in FIG. 7. Here, the ear loop member production device 1000 will be briefly described. Details will be described later.

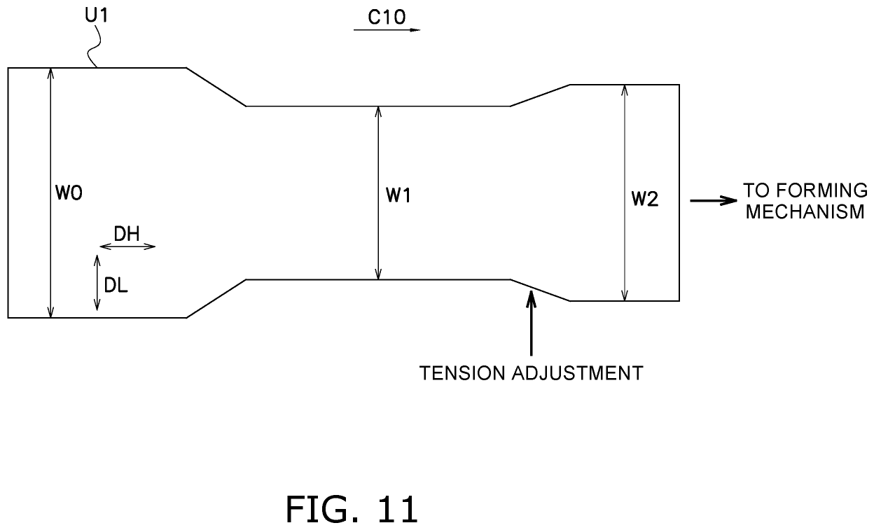

In the sheet roll 120, a band-like sheet U1 for forming the ear loop member assembly 4C is wound. The sheet U1 wound in the sheet roll 120 has a high-stretch direction DH and a low-stretch direction DL orthogonal to the high-stretch direction DH as shown in FIG. 11. It will be noted that FIG. 11 is a drawing showing an example of changes in the width of the sheet U1 during conveyance by the conveyance mechanism 1100 of the ear loop member production device 1000 (details will be described later). The sheet U1 is wound in the sheet roll 120 in such a way that the pull-out direction of the sheet U1 coincides with the high-stretch direction DH of the sheet U1.

The conveyance mechanism 1100 conveys to the forming mechanism 1200 the sheet U1 paid out from the sheet roll 120. The forming mechanism 1200 forms the ear loop member assembly 4C having a predetermined shape shown in FIG. 6 by cutting the sheet U1 conveyed by the conveyance mechanism 1100. More specifically, the forming mechanism 1200 forms the ear loop member assembly 4C by punching the sheet U1. The ear loop member assembly 4C formed by the forming mechanism 1200 is fed to the joining device 3000. The ear loop member assemblies 4C formed by the forming mechanism 1200 are conveyed in an attitude where they are along the first direction D1 (the high-stretch direction) and is fed to the joining device 3000.

(1-3-2) Process for Combining Mask Body, Intermediate Members, and Ear Loop Members

Next, a process for combining the mask body 2, the intermediate members 6, and the ear loop members 4 to finally produce the mask 10 will be described with reference mainly to FIG. 7 and FIG. 8.

It will be noted that in the following description there are cases where expressions stating that “B” is overlaid on “A” are used, but these are expressions for convenience of description, and even in cases where expressions stating that “B” is overlaid on “A” are used, in actuality “B” may be overlaid on “A”. Furthermore, expressions stating that “B” is overlaid on “A” here are not limited to the meaning that “A” is disposed on top of “B” but also include cases where “A” is disposed on the bottom of “B”.

The production system 100 mainly includes the joining device 3000, the joining device 150, and a cutting device 160 as devices for producing processes of the mask 10 by combining the mask body 2, the intermediate members 6, and the ear loop members 4.

In the joining device 3000, the intermediate member assemblies 6A conveyed from the cutting device 2100 are disposed overlying (see FIG. 8(B)) predetermined positions of the ear loop member assemblies 4C conveyed from the ear loop member production device 1000 (see FIG. 8(A)). More specifically, the intermediate member assemblies 6A are disposed straddling the base portion 42 of one ear loop member assembly 4C and the base portion 42 of another ear loop member assembly 42 that are adjacent. Then, the joining device 3000 welds, along the second direction D2, the second joint portions 14 of the intermediate members 6 and the base portions 42 of the ear loop members 4 (see FIG. 8(C)). The intermediate member assemblies 6A and the ear loop member assemblies 4C joined by the joining device 3000 are conveyed to the joining device 150 by a conveyance mechanism (not shown in the drawings). It will be noted that the intermediate member assemblies 6A and the ear loop member assemblies 4C conveyed to the joining device 150 are conveyed to the joining device 150 in an attitude where their conveyance direction C4 runs along the first direction D1.

In the joining device 150, the intermediate member assemblies 6A and the ear loop member assemblies 4C joined by the joining device 3000 are disposed overlying predetermined positions of the mask body sheet 2S conveyed from the integration device 112 (see FIG. 8(D)). Specifically, the intermediate member assemblies 6A and the ear loop member assemblies 4C are disposed overlying predetermined positions of the mask body sheet 2S in a state in which the ear loop member assemblies 4C are disposed between the mask body sheet 2S and the intermediate member assemblies 6A in the direction in which the mask body sheet 2S and the intermediate member assemblies 6A and ear loop member assemblies 4C are to overlay each other. Then, the joining device 150 welds, along the second direction D2, the first joint portions 12 of the intermediate members 6 and the end portions of the mask bodies 2 in the first direction D1 (see FIG. 8(E)). The intermediate member assemblies 6A, the ear loop member assemblies 4C, and the mask body sheet 2S joined by the joining device 150 are conveyed to the cutting device 160 by a conveyance mechanism (not shown in the drawings). It will be noted that the intermediate member assemblies 6A, the ear loop member assemblies 4C, and the mask body sheet 2S conveyed to the cutting device 160 are conveyed to the cutting device 160 in an attitude where their conveyance direction C5 runs along the first direction Dl.

The cutting device 160 cuts the intermediate member assemblies 6A along the second direction D2 at their middle portions in the first direction D1 (portions in the middle of adjacent first joint portions 12). The intermediate member assemblies 6A are each divided into two intermediate members 6, whereby the masks 10 are produced.

(2) Ear Loop Member Production Device

The ear loop member production device 1000 pertaining to an embodiment of the ear loop member production device of the present invention will be described.

(2-1) Overall Configuration of Ear Loop Member Production Device

The ear loop member production device 1000 includes the sheet roll 120, the conveyance mechanism 1100, and a forming mechanism 1200 (see FIG. 9)

In the sheet roll 120, the sheet U1 made of plastic nonwoven fabric serving as the raw material for the ear loop members 4 is wound. It will be noted that the sheet U1 has the high-stretch direction DH and the low-stretch direction DL orthogonal to the high-stretch direction DH (see FIG. 11). The sheet U1 is wound in the sheet roll 120 in such a way that the pull-out direction of the sheet U1 coincides with the high-stretch direction DH of the sheet U1.

The conveyance mechanism 1100 conveys to the forming mechanism 1200 the sheet U1 paid out from the sheet roll 120. It will be noted that the direction C10 in which the sheet U1 is conveyed by the conveyance mechanism 1100 (see FIG. 7) coincides with the high-stretch direction DH of the sheet U1. The conveyance mechanism 1100 conveys the sheet U1 while applying tension in the high-stretch direction DH to the sheet U1.

The forming mechanism 1200 forms the ear loop members 4 by cutting the sheet U1 conveyed by the conveyance mechanism 1100. Specifically, the forming mechanism 1200 forms the ear loop member assembly 4C, in which the pair of ear loop members 4 are interconnected, by cutting the sheet U1. The forming mechanism 1200 forms the ear loop member assembly 4C by punching the sheet U1.

(2-2) Detailed Configuration of Ear Loop Member Production Device

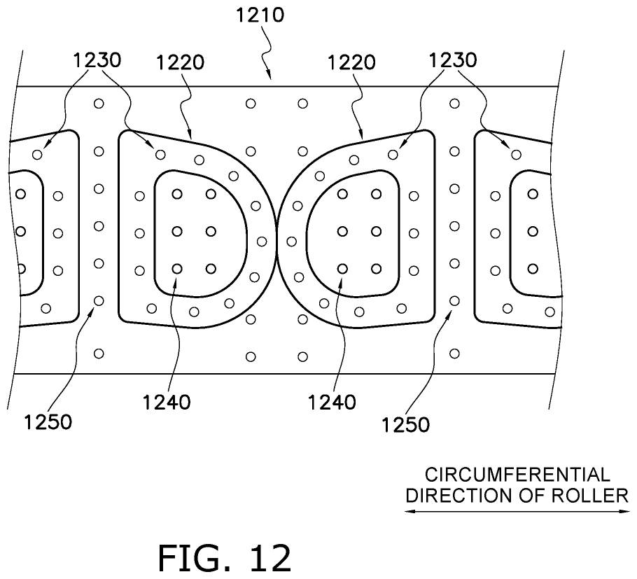

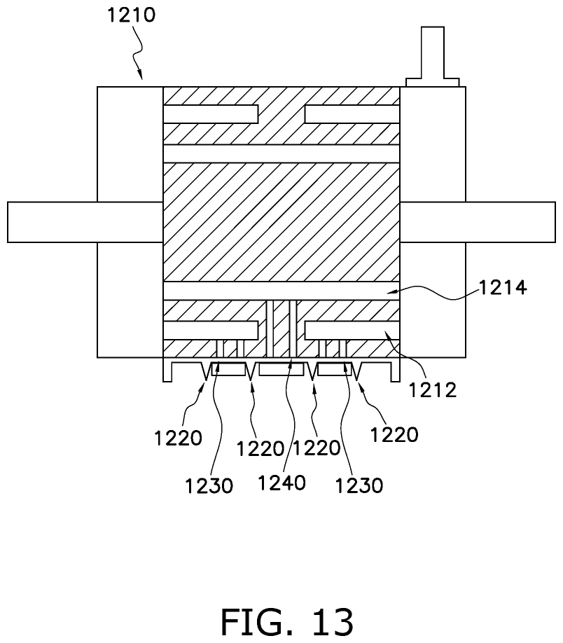

The conveyance mechanism 1100 and the forming mechanism 1200 of the ear loop member production device 1000 will be further described with reference to FIG. 9 and FIG. 11 to FIG. 13. FIG. 9 is, as mentioned above, a schematic configuration diagram of the ear loop member production device 1000, the intermediate member production device 2000, and the joining device 3000 for joining the ear loop members 4 and the intermediate members 6. FIG. 11 is a drawing showing an example of changes in the width of the sheet U1 during conveyance by the conveyance mechanism 1100 of the ear loop member production device 1000. FIG. 12 is a diagram schematically showing part of the outer peripheral surface of a first cut roll 1210 of the forming mechanism 1200 of the ear loop member production device 1000. FIG. 13 is a schematic sectional view for describing the internal structure of the forming mechanism 1200 of the ear loop member production device 1000.

(2-2-1) Conveyance Mechanism

The conveyance mechanism 1100 conveys along a predetermined path the sheet U1 paid out from the sheet roll 120. The conveyance mechanism 1100 mainly has plural rollers (reference signs omitted), a nip roll 1105, suction conveyors 1110, 1120, and a tension adjustment mechanism 1150 (see FIG. 9).

The plural rollers of the conveyance mechanism 1100 are mechanisms for guiding the sheet U1 along the predetermined path.

The nip roll 1105 is a mechanism that pulls and conveys the sheet U1 by using a drive mechanism such as a motor (not shown in the drawings) to cause rolls to rotate in a state in which the sheet U1 is sandwiched between them. The suction conveyors 1110, 1120 are mechanisms that convey the sheet U1 by using drive mechanisms such as motors (not shown in the drawings) to cause the conveyor belts to rotate while sucking the sheet U1 with conveyor belts having a suction function (conveyor belts that have suction holes (not shown in the drawings) formed on their surfaces and suck air through the suction holes to suck the sheet U1). The conveyance mechanism 1100 utilizes the nip roll 1105, the suction conveyors 1110, 1120, and the like to convey, in the conveyance direction C10 running along the high-stretch direction DH of the sheet U1, the sheet U1 while applying tension in the high-stretch direction DH to the sheet U1.

It will be noted that the reason the conveyance mechanism 1100 applies tension in the high-stretch direction DH of the sheet U1 when it conveys the sheet U1 in the conveyance direction C10 running along the high-stretch direction DH is to avoid meandering and misalignment of the conveyed sheet U1. In particular, by using the suction conveyors 1110, 1120 that convey the sheet U1 while sucking the sheet U1 at their surfaces, the sheet U1 can be stably conveyed and problems in the conveyance of the sheet U1 are particularly easily reduced.

The tension adjustment mechanism 1150 is a mechanism that adjusts the tension acting on the sheet U1. The tension adjustment mechanism 1150 is disposed upstream of the forming mechanism 1200 in the conveyance direction C10 of the sheet U1. The tension adjustment mechanism 1150 adjusts the tension acting on the sheet U1 just before the sheet U1 is fed to the forming mechanism 1200. The tension adjustment mechanism 1150 adjusts the tension acting on the sheet U1 to thereby adjust the width of the sheet U1 (the length of the sheet U1 in the direction orthogonal to the conveyance direction C10) to a predetermined width (a width W2) suitable for feeding the sheet U1 to the forming mechanism 1200. The sheet U1 whose tension (in other words, the width of the sheet U1) has been adjusted by the tension adjustment mechanism 1150 is fed to the forming mechanism 1200.

The role of the tension adjustment mechanism 1150 will be described more specifically with reference to FIG. 11.

For example, the sheet U1 whose length in the direction orthogonal to the conveyance direction C10 is a width W0 is wound in the sheet roll 120. Because it is difficult to convey the sheet U1 with the width W0 as is for reasons such as meandering of the sheet U1, the conveyance mechanism 1100 uses the nip roll 1105 and the suction conveyors 1110, 1120, for example, to convey the sheet U1 while applying tension suitable for conveyance to the sheet U1. At this time, because tension is applied in the high-stretch direction DH to the sheet U1, the sheet U1 deforms and its width decreases to a width W1. The extent of the change in dimension depends on the magnitude of the tension that is applied and the material of the used sheet U1. For example, the width W1 of the sheet U1 during conveyance is about 80% to 90% of the width W0.

However, this width W1 often differs from the predetermined width (width W2) suitable for processing of the sheet U1 in the forming mechanism 1200. Furthermore, the properties of the sheet U1 wound in the sheet roll 120 may vary slightly per sheet roll 120, and even if the width of the sheets U1 before tension is applied thereto is the same and the same tension is applied to the sheets U1 of the same material, the width of the sheet U1 when tension is applied thereto may not be constant. Therefore, here, the tension adjustment mechanism 1150 is provided, and the width of the sheet U1 fed to the forming mechanism 1200 is adjusted to the predetermined width W2 by adjusting the tension acting on the sheet U1.

As a result of the tension adjustment mechanism 1150 being configured as described above, the width of the sheet U1 first changes from the width W0 to the width W1 and is further adjusted from the width W1 to the width W2 as schematically shown in FIG. 11.

It will be noted that the magnitude of the tension adjusted in the tension adjustment mechanism 1150 (the speed at which the sheet U1 is conveyed by a first nip roll 1160 and a second nip roll 1170 described later) is, for example, determined for each used sheet roll 120, although this should not be construed as being limiting. In other words, the magnitude of the tension adjusted in the tension adjustment mechanism 1150 may be determined each time the sheet roll 120 is replaced.

Next, the specific configuration of the tension adjustment mechanism 1150 will be described.

The tension adjustment mechanism 1150 includes two nip rolls (a first nip roll 1160 and a second nip roll 1170) disposed along the conveyance direction C10 of the sheet U1. The second nip roll 1170 is disposed downstream of the first nip roll 1160 in the conveyance direction of the sheet U1. The first nip roll 1160 and the second nip roll 1170 are, like the nip roll 1105, mechanisms that pull and convey the sheet U1 by using drive mechanisms such as motors (not shown in the drawings) to cause rolls to rotate in a state in which the sheet U1 is sandwiched between them. The first nip roll 1160 and the second nip roll 1170 can change the conveyance speed of the sheet U1 by changing the rotational speed of the rolls. The tension adjustment mechanism 1150 adjusts the tension acting on the sheet U1 by differentiating the speed (a first speed V1) at which the sheet U1 is conveyed by the first nip roll 1160 and the speed (a second speed V2) at which the sheet U1 is conveyed by the second nip roll 1170.

For example, by making the second speed V2 smaller than the first speed V1, the tension acting on the sheet U1 can be reduced to increase the width of the sheet U1 from the width W1 to the width W2 as shown in FIG. 11. Furthermore, by making the second speed V2 larger than the first speed V1, the tension acting on the sheet U1 can be increased to reduce the width of the sheet U1.

It will be noted that the first nip roll 1160 and the second nip roll 1170 are examples of a first conveyance unit and a second conveyance unit, respectively, in the claims.

However, the first conveyance unit and the second conveyance unit are not limited to nip rolls as long as they are mechanisms capable of independently changing the conveyance speed of the sheet U1. For example, the first conveyance unit and the second conveyance unit need not have a structure in which they sandwich the sheet U1 between their members, and they may be rolls having a large coefficient of friction (rolls having surfaces on which the sheet U1 does not slide). By using such rolls, the conveyance speed of the sheet U1 can be changed and the tension acting on the sheet U1 can be adjusted in each conveyance unit.

(2-2-2) Forming Mechanism

The forming mechanism 1200 is a cutting device (a rotary die cutter) mainly including a cut roll 1210 (hereinafter called a first cut roll 1210 to avoid confusion) and an anvil roll 1260 (hereinafter called a first anvil roll 1260 to avoid confusion) (see FIG. 9).

In the forming mechanism 1200, the first cut roll 1210, which is provided with cutting blades 1220 on its outer peripheral surface, is driven to rotate by a drive mechanism (not shown in the drawings) such as a motor. The first anvil roll 1260 rotates along with the rotation of the first cut roll 1210. In the example of FIG. 9, the first cut roll 1210 rotates counterclockwise and the first anvil roll 1260 rotates clockwise. The forming mechanism 1200 rotates the first cut roll 1210 and brings the cutting blades 1220 into contact with the sheet U1, thereby cutting the sheet U1 between the first cut roll 1210 and the first anvil roll 1260 to cut out the ear loop members 4. More specifically, the forming mechanism 1200 cuts the sheet U1 between the first cut roll 1210 and the first anvil roll 1260 to cut out the ear loop member assemblies 4C in which the pairs of the ear loop members 4 are interconnected.

This will be described in greater detail.

The outer peripheral surface of the first cut roll 1210 is provided with the cutting blades 1220 having the same shape as the contours of the ear loop member assemblies 4C (see FIG. 12). In contrast, the first anvil roll 1260 is not provided with cutting blades but is smooth. The first anvil roll 1260 is disposed in opposition to the outer peripheral surface of the first cut roll 1210. The sheet U1 passing between the first cut roll 1210 and the first anvil roll 1260 is cut by the cutting blades 1220 of the first cut roll 1210, so that the sheet U1 is cut out in the shape of the ear loop member assemblies 4C.

It will be noted that plural holes 1230, 1240, 1250 are formed in the outer peripheral surface of the first cut roll 1210 (see FIG. 12). The holes 1230, 1240, 1250 communicate with air passages 1212, 1214 and the like provided inside the first cut roll 1210 and communicate via the air passages 1212, 1214 and ducts (not shown in the drawings) with a vacuum suction device such as a vacuum pump. The rotation (change in the rotation angle) of the first cut roll 1210 switch the communicated state and non-communicated state between the holes 1230, 1240, 1250 and the vacuum suction device. When the holes 1230, 1240, 1250 are in communication with the vacuum suction device, air is sucked through the holes 1230, 1240, 1250 and the sheet U1 is sucked and held by the holes 1230, 1240, 1250.

It will be noted that the holes 1230, 1240, 1250 are used to cooperatively suck and hold the sheet U1 before the ear loop member assemblies 4C are cut out and to hold a part of the sheet U1, as explained later, after the sheet U1 has been cut by the cutting blades 1220.

The holes 1230 are disposed inside the cutting blades 1220 provided in the shape of the contours of the ear loop member assemblies 4C. The holes 1230 are used to suck and hold the ear loop member assemblies 4C cut out by the cutting blades 1220.

The holes 1240 are disposed in positions corresponding to the holes 46 in the ear loop members 4 for allowing them to be looped around ears. The holes 1240 are used to suck and hold waste material (called intermittent trim) that has the same shape as the holes 46 of the ear loop members 4 and is generated when the ear loop member assemblies 4C are cut out.

The holes 1250 are disposed outside the cutting blades 1220. The holes 1250 are used to suck and hold waste material (waste material other than the intermittent trim; called continuous trim) around the cutting blades 1220 that is generated when the ear loop member assemblies 4C are cut out. It will be noted that the holes 1250 are configured to also be communicable with a compressed air supply device so that they can assist in separating the continuous trim from the first cut roll 1210 by blowing out air at a predetermined timing.

The holes 1230, 1240, 1250 do not always suck air. Rather, suction and non-suction is switched depending on the rotational angle of the first cut roll 1210 as mentioned above. Because of this, the holes 1230, 1240, 1250 can hold at predetermined timings, and cancel holding at predetermined timings, the ear loop member assemblies 4C, the intermittent trim, and the continuous trim. Furthermore, suction and non-suction by the holes 1230, 1240, 1250 is switched at respectively different timings by communicating with respectively different air passages (e.g., the air passages 1212, 1214, etc.) provided inside the first cut roll 1210. Because of this, the holding of the ear loop member assemblies 4C, the intermittent trim, and the continuous trim can be switched at respective predetermined timings.

For example, the continuous trim generated by cutting the sheet U1 changes its conveyance direction so that it wraps around the first anvil roll 1260 as shown in FIG. 9 and is sucked in the direction of the arrow by a suction device (not shown in the drawings). For that reason, the suction of the holes 1250 that suck the continuous trim portion is canceled roughly at a timing when the holes 1250 pass the uppermost point. It will be noted that it is preferred that compressed air be discharged from the holes 1250 to assist the separation of the continuous trim after the holes 1250 cancel the suction.

The intermittent trim generated by cutting the sheet U1 is sucked obliquely upward by a suction device (not shown in the drawings) at the position shown in FIG. 9. For that reason, the suction of the holes 1240 that suck the intermittent trim portions is canceled roughly at the timing when the holes 1240 pass the vicinity of the suction device for the intermittent trim (not shown in the drawings).

Furthermore, the ear loop member assemblies 4C formed by cutting the sheet U1 are transferred to the pattern anvil roll 3100 of the joining device 3000 described later. Here, the pattern anvil roll 3100 is disposed directly under the first anvil roll 1260. For that reason, the suction of the holes 1230 that suck the ear loop member assembly 4C portions is canceled roughly at the timing when the holes 1230 pass the lowest point.

It will be noted that the timings of the cancelation of the suction by the holes 1230, 1240, 1250 described here differ depending on the device arrangement, for example, so they are not limited to the timings exemplified here.

(3) Method of Producing Ear Loop Members

A method of producing the ear loop members 4 (more specifically, a method of producing the ear loop member assembly 4C in which the pair of ear loop members 4 are interconnected) will be described. It will be noted that, here, in addition to the method of producing the ear loop members 4, the process for joining the ear loop members 4 and the intermediate members 6 will also be described.

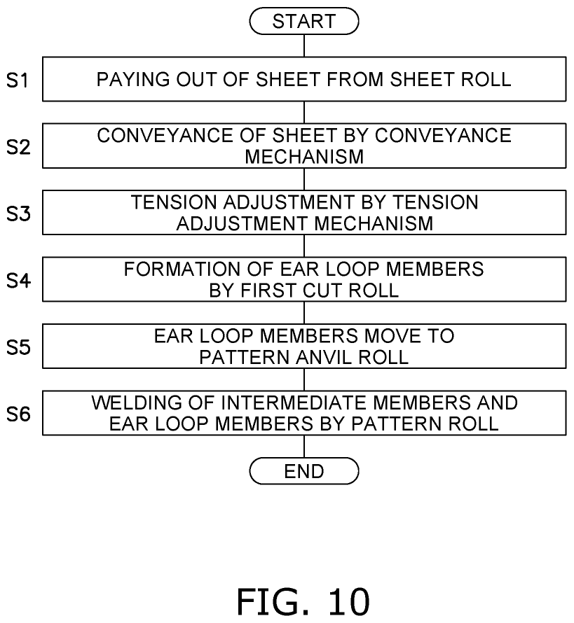

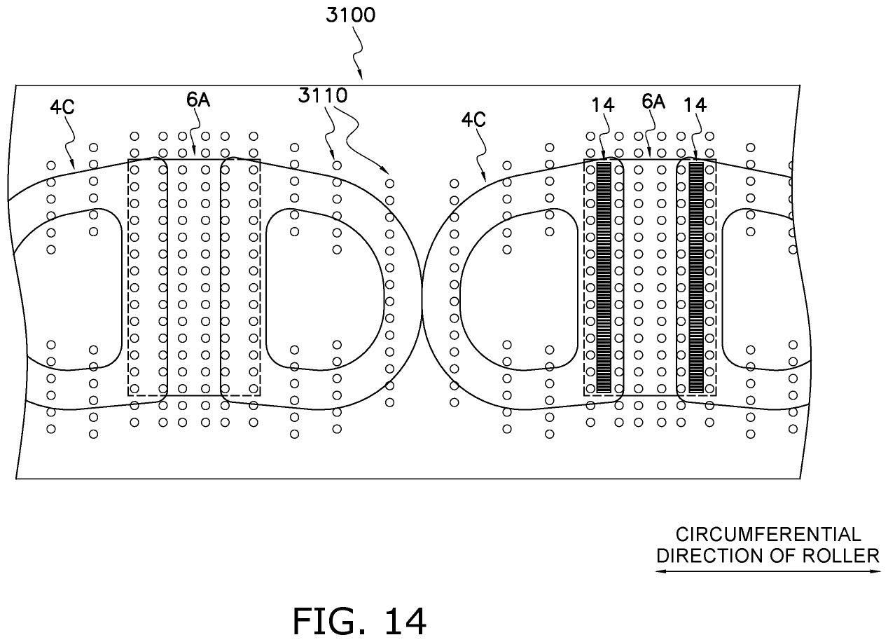

Here, further reference will be made to FIG. 10 and FIG. 14. FIG. 10 is a flowchart of steps for producing the ear loop members 4 (the ear loop member assembly 4C). FIG. 14 is a diagram schematically showing part of the outer peripheral surface of the pattern anvil roll 3100 of the joining device 3000. FIG. 14 illustrates a state in which the pattern anvil roll 3100 is holding intermediate member assemblies 6A and ear loop member assemblies 4C on its outer peripheral surface. Furthermore, in FIG. 14, the intermediate member assembly 6A and the ear loop member assembly 4C on the right side are shown in a state after being joined and the intermediate member assembly 6A and the ear loop member assembly 4C on the left side are shown in a state before being joined.

When producing the ear loop members 4, first, the sheet U1 is paid out from the sheet roll 120 (step S1 in FIG. 10). It will be noted that because the sheet U1 is wound in the sheet roll 120 along the high-stretch direction DH, the sheet U1 paid out from the sheet roll 120 is conveyed in the high-stretch direction DH.

Next, the sheet U1 is conveyed in the conveyance direction C10 running along the high-stretch direction DH while tension is applied in the high-stretch direction DH to the sheet U1 by the conveyance mechanism 1100 (step S2 in FIG. 10). In particular, here, the sheet U1 is conveyed at least locally by the suction conveyors 1110, 1120. The suction conveyors 1110, 1120 convey the sheet U1 while sucking it at their surfaces. By using the suction conveyors 1110, 1120, the sheet U1 can be conveyed while inhibiting misalignment and the like of the sheet U1.

Next, the tension in the sheet U1 conveyed as far as the tension adjustment mechanism 1150 is adjusted by the tension adjustment mechanism 1150 (step S3 in FIG. 10). In particular, here, the adjustment of the tension acting on the sheet U1 is performed so that the width of the sheet U1 (its length in the direction orthogonal to the conveyance direction C10) becomes the width W2. The way in which the adjustment of the tension is performed by the tension adjustment mechanism 1150 has already been described, so description will be omitted here.

Next, the sheet U1 after the tension adjustment (after the width adjustment) by the tension adjustment mechanism 1150 is fed to the forming mechanism 1200, where the sheet U1 is cut into a predetermined shape by the cutting blades 1220 of the first cut roll 1210 to form the ear loop member assembly 4C (step S4 in FIG. 10).

The ear loop member assembly 4C formed by the forming mechanism 1200 moves in a state in which it is sucked and held by the first cut roll 1210, and is transferred to the pattern anvil roll 3100 of the joining device 3000 (step S5 in FIG. 10).

In the outer peripheral surface of the pattern anvil roll 3100 are formed plural holes 3110. The plural holes 3110 communicate with a vacuum suction device such as a vacuum pump through a duct or the like (not shown in the drawings). Because the plural holes 3110 communicate with the vacuum suction device, air is sucked through the holes 3110 so that the intermediate member assembly 6A and the ear loop member assembly 4C are sucked and held by the holes 3110. It will be noted that the holes 3110 do not always suck air but the rotational angle of the pattern anvil roll 3100 switches suction and non-suction by the holes 3110.

It will be noted that the intermediate member assembly 6A produced by the intermediate member production device 2000 is transferred from the second anvil roll 2120 and sucked by the pattern anvil roll 3100 before the ear loop member assembly 4C is sucked. Consequently, at the pattern anvil roll 3100, the ear loop member assembly 4C is at least partially held on the outer peripheral surface of the pattern anvil roll 3100 by the suction of air through the holes 3110 via the intermediate member assembly 6A being sucked and held beforehand on the pattern anvil roll 3100. Each ear loop member assembly 4C is sucked and held on the pattern anvil roll 3100 so as to overlie two intermediate member assemblies 6A being sucked and held beforehand on the pattern anvil roll 3100.

Here, the arrangement of the holes 3110 in the outer peripheral surface of the pattern anvil roll 3100 will be described. The holes 3110 are provided in correspondence to positions where the second anvil roll 2120 transfers the intermediate member assemblies 6A and positions where the first cut roll 1210 transfers the ear loop member assemblies 4C. That is, here, the first cut roll 1210, the second anvil roll 2120, and the pattern anvil roll 3100 rotate synchronously, and the pattern anvil roll 3100 is configured to suck and hold the intermediate member assemblies 6A and the ear loop member assemblies 4C at predetermined positions on its outer peripheral surface.

It will be noted that, as shown in FIG. 14, the holes 3110 are formed not only in positions coinciding with the intermediate member assemblies 6A and the ear loop member assemblies 4C that are sucked but also in regions wider than the places where the intermediate member assemblies 6A and the ear loop member assemblies 4C are disposed in the width direction (in the up and down direction in FIG. 14). By forming the holes 3110 in regions wider than the positions where the intermediate member assemblies 6A and the ear loop member assemblies 4C are disposed in this way, the problem of upward curling of the intermediate member assemblies 6A and the ear loop member assemblies 4C caused by the flow of air can be inhibited.

Returning now to the description of the production process, the intermediate member assemblies 6A and the ear loop member assemblies 4C being held by the pattern anvil roll 3100 are moved by the rotation of the pattern anvil roll 3100 by a drive mechanism (not shown in the drawings) such as a motor. The intermediate member assemblies 6A and the ear loop member assemblies 4C pass between the pattern anvil roll 3100 and a pattern roll 3200 which, like the pattern anvil roll 3100, is driven to rotate by a drive mechanism (not shown in the drawings) such as a motor. At this time, the second joint portions 14 of the intermediate members 6 and the base portions 42 of the ear loop members 4 are joined between sealing members 3210 provided on the outer peripheral surface of the pattern roll 3200 (see FIG. 9) and the pattern anvil roll 3100 (step S6). For example, the sealing members 3210 use a heater as a heat source to weld the second joint portions 14 of the intermediate members 6 and the base portions 42 of the ear loop members 4. It will be noted that the rotational operation of the pattern roll 3200 is controlled synchronously with the rotational operation of the pattern anvil roll 3100 so that the sealing members 3210 make contact a portion between the holes 3110 in the outer peripheral surface of the pattern anvil roll 3100 (i.e., the sealing members 3210 do not make contact with the hole 3110 portions of the outer peripheral surface of the pattern anvil roll 3100).

The intermediate member assemblies 6A and the ear loop member assemblies 4C joined by the joining device 3000 are conveyed to the joining device 150 by a conveyance mechanism (not shown in the drawings) as mentioned above.

(4) Characteristics

(4-1)

The method of producing the ear loop members 4 for the masks 10 of the above embodiment includes the conveyance step (step S2 in FIG. 10), the tension adjustment step (step S3 in FIG. 10), and the forming step (step S4 in FIG. 10). In the conveyance step, the sheet U1 having high stretchability in the high-stretch direction DH (a first direction in the claims) is conveyed in the conveyance direction running along the high-stretch direction DH while tension is applied in the high-stretch direction DH to the sheet U1. In the tension adjustment step, the tension in the conveyed sheet U1 is adjusted. In the forming step, the ear loop members 4 are formed by cutting the sheet U1 after the tension adjustment.

Furthermore, the device 1000 for producing ear loop members for the masks 10 of the above embodiment includes the sheet roll 120, the conveyance mechanism 1100, and the forming mechanism 1200. In the sheet roll 120, the sheet U1 having high stretchability in the high-stretch direction DH is wound. The conveyance mechanism 1100 conveys, in the conveyance direction C10 running along the high-stretch direction DH, the sheet U1 paid out from the sheet roll 120, while applying tension in the high-stretch direction DH to the sheet U1. The forming mechanism 1200 forms the ear loop members 4 by cutting the sheet U1 conveyed by the conveyance mechanism 1100. The conveyance mechanism 1100 has the tension adjustment mechanism 1150. The tension adjustment mechanism 1150 is disposed upstream of the forming mechanism 1200 in the conveyance direction C10 of the sheet U1 and adjusts the tension in the sheet U1 fed to the forming mechanism 1200.

In the method of producing the ear loop members 4 and the ear loop member production device 1000 of the present embodiment, a step for changing the relative positions of the mask bodies 2 and the ear loop members 4 is unnecessary even in a case where the mask bodies 2 are conveyed in the low-stretch direction, and a reduction in the production efficiency of the masks 10 can be inhibited.

Furthermore, in the method of producing the ear loop members 4 and the ear loop member production device 1000 of the present embodiment, the sheet U1 is conveyed in a state in which tension is applied in the high-stretch direction DH to the sheet U1, so even when the sheet U1 is conveyed in the high-stretch direction DH, meandering and misalignment of the conveyed sheet U1 can be inhibited.

Moreover, in the method of producing the ear loop members 4 and the ear loop member production device 1000 of the present embodiment, the adjustment of the tension in the conveyed sheet U1 is performed before the ear loop members 4 are formed, so the sheet U1 deformed by tension can be returned to an appropriate dimension and then fed to the forming mechanism 1200 for forming the ear loop members 4. For that reason, the ear loop members 4 having a predetermined shape can be accurately produced.

(4-2)

In the method of producing the ear loop members 4 for the masks 10 of the above embodiment, the tension adjustment step (step S3) includes a step of changing the conveyance speed of the sheet U1.

In this production method, the tension in the sheet U1 can be easily adjusted.

(4-3)

In the device 1000 for producing ear loop members for the masks 10 of the above embodiment, the tension adjustment mechanism 1150 includes the first nip roll 1160 serving as a first conveyance unit that conveys the sheet U1 at the first speed V1 and the second nip roll 1170 serving as a second conveyance unit that is disposed downstream of the first nip roll 1160 in the conveyance direction C10 and conveys the sheet U1 at the second speed V2 different from the first speed Vl.

In the ear loop member production device 1000, the tension in the sheet U1 can be easily adjusted.

In particular, because each of the first conveyance unit and the second conveyance unit is a nip roll, the tension in the sheet U1 can be accurately adjusted.

However, the first conveyance unit and the second conveyance unit are not limited to the nip rolls and may be other mechanisms capable of changing the conveyance speed of the sheet U1.

(4-4)

In the device 1000 for producing ear loop members for the masks 10 of the above embodiment, the conveyance mechanism 1100 includes the suction conveyors 1110, 1120 disposed upstream of the tension adjustment mechanism 1150 in the conveyance direction C10 of the sheet U1.

By using the suction conveyors 1100, 1120 in the conveyance mechanism 1100, the sheet U1 can be conveyed in a particularly stable state.

(5) Example Modifications

Example modifications of the above embodiment will be described below. It will be noted that the following example modifications may be combined as appropriate to the extent that they are not mutually incompatible.

(5-1) Example Modification A

The method of producing ear loop members and the device for producing ear loop members for masks described in the above embodiment should not be construed as limiting the type and shape of the masks.

For example, in the above embodiment, the mask 10 includes three members, the mask body 2, the intermediate members 6, and the ear loop members 4, but the ear loop member production method and the ear loop member production device of the present invention may also be utilized as a method of producing ear loop members and a device for producing ear loop members for masks that do not have the intermediate members 6. In other words, the method of producing ear loop members and the device for producing ear loop members for masks of the present invention may also be utilized to produce ear loop members that are directly joined to the mask body.

Furthermore, in the above embodiment, the mask 10 is a pleated mask, but it is not limited to this. The ear loop members produced by the production method and the production device of the present invention may also be utilized for flat masks without pleats or 3D masks.

Furthermore, the ear loop member production method and the ear loop member production device of the present invention may also be applied to producing ear loop members and ear loop member assemblies having shapes different from those described in the above embodiment.

Finally, technical concepts that can be grasped from the above embodiment and other examples (example modifications) are appended below.

A method of producing ear loop members for masks pertaining to a first aspect of the invention includes a conveyance step, a tension adjustment step, and a forming step. In the conveyance step, a sheet having high stretchability in a first direction is conveyed in a conveyance direction running along the first direction while tension is applied in the first direction to the sheet. In the tension adjustment step, the tension in the conveyed sheet is adjusted. In the forming step, ear loop members are formed by cutting the sheet after the tension adjustment.

In the method of producing ear loop members for masks of the first aspect of the invention, a step for changing the relative positions of the mask bodies and the ear loop members is unnecessary even in a case where the mask bodies are conveyed in the low-stretch direction, and a reduction in the production efficiency of the masks can be inhibited.

Furthermore, in the method of producing ear loop members for masks of the first aspect of the invention, the sheet is conveyed in a state in which tension is applied in the first direction to the sheet, so even when the sheet is conveyed in the high-stretch direction, meandering and misalignment of the conveyed sheet can be inhibited.

Moreover, in the method of producing ear loop members for masks of the first aspect of the invention, the adjustment of the tension in the conveyed sheet is performed before the ear loop members are formed, so the sheet deformed by tension can be returned to an appropriate dimension and then fed to the forming mechanism for forming the ear loop members. For that reason, ear loop members having a predetermined shape can be accurately produced.

A method of producing ear loop members for masks pertaining to a second aspect of the invention is the method of producing ear loop members for masks of the first aspect, wherein the tension adjustment step includes a step of changing the conveyance speed of the sheet.

In the method of producing ear loop members for masks pertaining to the second aspect of the invention, the tension in the sheet can be easily adjusted.

A device for producing ear loop members for masks pertaining to a third aspect of the invention includes a sheet roll, a conveyance mechanism, and a forming mechanism. In the sheet roll, a sheet having high stretchability in a first direction is wound. The conveyance mechanism is configured to convey, in a conveyance direction running along the first direction, the sheet paid out from the sheet roll, while applying tension in the first direction to the sheet. The forming mechanism is configured to form ear loop members by cutting the sheet conveyed by the conveyance mechanism. The conveyance mechanism has a tension adjustment mechanism. The tension adjustment mechanism is disposed upstream of the forming mechanism in the conveyance direction of the sheet and is configured to adjust the tension in the sheet fed to the forming mechanism.

In the device for producing ear loop members for masks of the third aspect of the invention, a step for changing the relative positions of the mask bodies and the ear loop members is unnecessary even in a case where the mask bodies are conveyed in the low-stretch direction, and a reduction in the production efficiency of the masks can be inhibited.

Furthermore, in the device for producing ear loop members for masks of the third aspect of the invention, the sheet is conveyed in a state in which tension is applied in the first direction to the sheet, so even when the sheet is conveyed in the high-stretch direction, meandering and misalignment of the conveyed sheet can be inhibited.

Moreover, in the device for producing ear loop members for masks of the third aspect of the invention, the adjustment of the tension in the conveyed sheet is performed before the ear loop members are formed, so the sheet deformed by tension can be returned to an appropriate dimension and then fed to the forming mechanism for forming the ear loop members. For that reason, ear loop members having a predetermined shape can be accurately produced.

A device for producing ear loop members for masks pertaining to a fourth aspect of the invention is the device for producing ear loop members for masks of the third aspect, wherein the tension adjustment mechanism includes a first conveyance unit configured to conveys the sheet at a first speed and a second conveyance unit that is disposed downstream of the first conveyance unit in the conveyance direction and is configured to convey the sheet at a second speed different from the first speed.

In the device for producing ear loop members for masks of the fourth aspect of the invention, the tension in the sheet can be easily adjusted.

A device for producing ear loop members for masks pertaining to a fifth aspect of the invention is the device for producing ear loop members for masks of the fourth aspect, wherein each of the first conveyance unit and the second conveyance unit is a nip roll.

In the device for producing ear loop members for masks of the fifth aspect of the invention, the tension in the sheet can be accurately adjusted.

A device for producing ear loop members for masks pertaining to a sixth aspect of the invention is the device for producing ear loop members for masks of any of the third aspect to the fifth aspect, wherein the conveyance mechanism has suction conveyors disposed upstream of the tension adjustment mechanism in the conveyance direction of the sheet.

In the device for producing ear loop members for masks of the sixth aspect of the invention, by using the suction conveyors in the conveyance mechanism, the sheet can be conveyed in a particularly stable state.

### REFERENCE SIGNS LIST

4 Ear Loop Members

120 Sheet Roll

1000 Ear Loop Member Production Device

1100 Conveyance Mechanism

1110, 1120 Suction Conveyors

1150 Tension Adjustment Mechanism

1160 First Nip Roll (First Conveyance Unit)

1170 Second Nip Roll (Second Conveyance Unit)

1200 Forming Mechanism

C10 Conveyance Direction

DH High-stretch Direction (First Direction)

S2 Conveyance Step

S3 Tension Adjustment Step

S4 Forming Step

U1 Sheet

### CITATION LIST

### Patent Literature

Patent Document 1: JP-A No. 2012-217651

1. A method of producing ear loop members for masks comprising:
a conveyance step of conveying a sheet having high stretchability in a first direction in a conveyance direction running along the first direction while applying tension in the first direction to the sheet;
a tension adjustment step of adjusting the tension in the conveyed sheet; and
a forming step of forming ear loop members by cutting the sheet after the tension adjustment.

2. The method of producing ear loop members for masks according to claim 1, wherein the tension adjustment step includes a step of changing the conveyance speed of the sheet.

3. A device for producing ear loop members for masks comprising:
a sheet roll in which is wound a sheet having high stretchability in a first direction;
a conveyance mechanism configured to convey, in a conveyance direction running along the first direction, the sheet paid out from the sheet roll, while applying tension in the first direction to the sheet; and
a forming mechanism configured to form ear loop members by cutting the sheet conveyed by the conveyance mechanism,
wherein the conveyance mechanism has a tension adjustment mechanism that is disposed upstream of the forming mechanism in the conveyance direction of the sheet and is configured to adjust the tension in the sheet fed to the forming mechanism.

4. The device for producing ear loop members for masks according to claim 3, wherein the tension adjustment mechanism includes a first conveyance unit configured to convey the sheet at a first speed and a second conveyance unit disposed downstream of the first conveyance unit in the conveyance direction and configured to convey the sheet at a second speed different from the first speed.

5. The device for producing ear loop members for masks according to claim 4, wherein each of the first conveyance unit and the second conveyance unit is a nip roll.

6. The device for producing ear loop members for masks according to claim 3, wherein the conveyance mechanism has suction conveyors disposed upstream of the tension adjustment mechanism in the conveyance direction.

7. The device for producing ear loop members for masks according to claim 4, wherein the conveyance mechanism has suction conveyors disposed upstream of the tension adjustment mechanism in the conveyance direction.

8. The device for producing ear loop members for masks according to claim 5, wherein the conveyance mechanism has suction conveyors disposed upstream of the tension adjustment mechanism in the conveyance direction.
